(19) United States
(12) Patent Application Publication
(10) Pub. No.: US 2024/0258537 A1
(43) Pub. Date: Aug. 1, 2024

(54) FUEL CELL SYSTEM

(71) Applicant: TOYOTA JIDOSHA KABUSHIKI KAISHA, Toyota-shi (JP)

(72) Inventor: Michito NORIMOTO, Miyoshi-shi (JP)

(21) Appl. No.: 18/420,869

(22) Filed: Jan. 24, 2024

(30) Foreign Application Priority Data
Jan. 27, 2023 (JP) 2023-010709

(51) Int. Cl. H01M 8/04082; H01M 8/04537; H01M 8/04746

(52) U.S. Cl. CPC H01M 8/04201; H01M 8/04552; H01M 8/04753

(57) ABSTRACT

To provide a fuel cell system capable of improving a rate of discharging fuel gas. A fuel cell system, wherein the fuel cell system comprises a fuel cell, an oxidant gas supply pipe, a fuel gas supply pipe, a connection pipe, a voltage sensor and a control unit; wherein the connection pipe connects the oxidant gas supply pipe and the fuel gas supply pipe; wherein a connection valve is disposed in the connection pipe; wherein the voltage sensor is configured to measure a voltage of the fuel cell; wherein the control unit is configured to control opening and closing of the connection valve; and wherein the control unit is configured to preliminarily store a first threshold value and a second threshold value of the voltage of the fuel cell.

### TECHNICAL FIELD

The present disclosure relates to a fuel cell system.

### BACKGROUND

Various studies have been made on fuel cells (FC). Patent Literature 1 discloses a fuel cell system that discharges anode gas from a fuel cell system by supplying inert gas.
Patent Literature 1: Japanese Patent Application Laid-Open (JP-A) No. 2020-047418

In the prior art, since the working time for connecting the cylinder for supplying the inert gas to the fuel cell system is long, the time taken from the entrance to delivery of a moving body such as a vehicle equipped with the fuel cell system, becomes long.

### SUMMARY

The disclosure was achieved in light of the above circumstances. An object of the disclosure is to provide a fuel cell system capable of improving the speed of discharging fuel gas.

The fuel cell system of the present disclosure is a fuel cell system,
wherein the fuel cell system comprises a fuel cell, an oxidant gas supply pipe, a fuel gas supply pipe, a connection pipe, a voltage sensor and a control unit;
wherein the connection pipe connects the oxidant gas supply pipe and the fuel gas supply pipe;
wherein a connection valve is disposed in the connection pipe;
wherein the voltage sensor is configured to measure a voltage of the fuel cell;
wherein the control unit is configured to control opening and closing of the connection valve;
wherein the control unit is configured to preliminarily store a first threshold value and a second threshold value of the voltage of the fuel cell;
wherein, when the control unit starts a charge removal process of the fuel cell when the fuel cell is stopped, the control unit is configured to supply the oxidant gas to a cathode of the fuel cell and closes the connection valve;
wherein, when the voltage of the fuel cell decreases to the first threshold value, the control unit is configured to stop the supply of the oxidant gas to the cathode of the fuel cell, and the control unit is configured to supply the oxidant gas to an anode of the fuel cell by opening the connection valve; and
wherein, when the voltage of the fuel cell decreases to the second threshold value, the control unit is configured to close the connection valve.

The fuel cell system of the present disclosure is a fuel cell system,
wherein the fuel cell system comprises a fuel cell and a fuel gas supply pipe, and
wherein the fuel gas supply pipe includes a connection port to which a cylinder for supplying an inert gas can be connected.

In the fuel cell system of the present disclosure, the fuel gas supply pipe may include a connection port to which a cylinder for supplying an inert gas can be connected.

The present disclosure can provide the fuel cell system capable of improving the speed of discharging fuel gas.

### BRIEF DESCRIPTION OF THE DRAWINGS

In the accompanying drawings,

FIG. 1 shows a system configuration diagram illustrating an example of the fuel cell system of the present disclosure;

FIG. 2 shows a flowchart showing an example of voltage control performed by the fuel cell system of the present disclosure; and

FIG. 3 shows a diagram for explaining the relationship between the state of the fuel cell, a gas present in the fuel gas system of the fuel cell, a gas present in the anode, a gas present in the cathode, and the voltage of the fuel cell.

### DETAILED DESCRIPTION

The fuel cell system of the present disclosure is a fuel cell system,
wherein the fuel cell system comprises a fuel cell, an oxidant gas supply pipe, a fuel gas supply pipe, a connection pipe, a voltage sensor and a control unit;
wherein the connection pipe connects the oxidant gas supply pipe and the fuel gas supply pipe;
wherein a connection valve is disposed in the connection pipe;
wherein the voltage sensor is configured to measure a voltage of the fuel cell;
wherein the control unit is configured to control opening and closing of the connection valve;
wherein the control unit is configured to preliminarily store a first threshold value and a second threshold value of the voltage of the fuel cell;
wherein, when the control unit starts a charge removal process of the fuel cell when the fuel cell is stopped, the control unit is configured to supply the oxidant gas to a cathode of the fuel cell and closes the connection valve;
wherein, when the voltage of the fuel cell decreases to the first threshold value, the control unit is configured to stop the supply of the oxidant gas to the cathode of the fuel cell, and the control unit is configured to supply the oxidant gas to an anode of the fuel cell by opening the connection valve; and
wherein, when the voltage of the fuel cell decreases to the second threshold value, the control unit is configured to close the connection valve.

### First Embodiment

A fuel cell system according to a first embodiment of the present disclosure includes a fuel cell, an oxidant gas supply pipe, a fuel gas supply pipe, a connection pipe, a voltage sensor, and a controller. The fuel cell system of the present disclosure may include an oxidant gas system, a fuel gas system, and a cooling system.

The fuel cell system of the present disclosure may be mounted on a moving body such as a vehicle and used. Further, the fuel cell system of the present disclosure may be mounted on a generator that supplies electric power to the outside. The vehicle may be a fuel cell vehicle or the like. Examples of the moving body other than the vehicle include a railway, a ship, and an aircraft. Further, the fuel cell system of the present disclosure may be mounted on a moving body such as a vehicle capable of traveling even with electric power of a secondary battery. The vehicle may comprise the fuel cell system of the present disclosure. The moving body may include a drive unit such as a motor, an inverter, and a hybrid control system. The hybrid control system may be capable of driving a moving body by using both the output of the fuel cell and the electric power of the secondary battery.

The fuel cell may have only one single cell, or may be a fuel cell stack (sometimes referred to as a FC stack, a stack, or the like) which is a stacked body in which a plurality of single cells are stacked. In the present disclosure, both the single cell and the fuel cell stack may be referred to as a fuel cell. The number of stacked single cells is not particularly limited, and may be, for example, 2 to several hundred.

A single cell of a fuel cell typically includes a membrane electrode gas diffusion layer assembly.

The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes a cathode catalyst layer and a cathode-side gas diffusion layer.

The anode (fuel electrode) includes an anode catalyst layer and an anode-side gas diffusion layer.

The cathode catalyst layer and the anode catalyst layer are collectively referred to as a catalyst layer.

The catalyst layer may include, for example, a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The cathode-side gas diffusion layer and the anode-side gas diffusion layer are collectively referred to as a gas diffusion layer.

The gas diffusion layer may be a conductive member or the like having gas permeability.

Examples of the conductive member include a carbon porous body such as carbon cloth and carbon paper, and a metal porous body such as a metal mesh and a metal foam.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The single cell may include two separators that sandwich both surfaces of the membrane electrode gas diffusion layer assembly as needed. The two separators are one anode-side separator and the other cathode-side separator. In the present disclosure, the anode-side separator and the cathode-side separator are collectively referred to as a separator.

The separator may have holes constituting a manifold such as a supply hole and a discharge hole for allowing a fluid such as a reaction gas and a cooling medium to flow in the stacking direction of the single cells.

As the cooling medium, for example, cooling water such as a mixed solution of ethylene glycol and water can be used in order to prevent freezing at low temperatures. As the cooling medium, air for cooling can be used.

Examples of the supply hole include a fuel gas supply hole, an oxidant gas supply hole, and a cooling medium supply hole.

Examples of the discharge hole include a fuel gas discharge hole, an oxidant gas discharge hole, and a cooling medium discharge hole.

The separator may have a reaction gas flow path on a surface in contact with the gas diffusion layer. In addition, the separator may have a cooling medium flow path for keeping the temperature of the fuel cell constant on a surface opposite to the surface in contact with the gas diffusion layer.

The separator may be a gas impermeable conductive member or the like. The conductive member may be, for example, dense carbon obtained by compressing carbon to make it gas-impermeable, or a press-formed metal (for example, iron, aluminum, stainless steel, or the like) plate. In addition, the separator may have a current collecting function.

The fuel cell stack may include a manifold such as an inlet manifold in which the supply holes are in communication with each other and an outlet manifold in which the discharge holes are in communication.

Inlet manifolds include anode inlet manifolds, cathode inlet manifolds, and cooling medium inlet manifolds.

Outlet manifolds include anode outlet manifolds, cathode outlet manifolds, and cooling medium outlet manifolds.

In the present disclosure, the fuel gas and the oxidizing gas are collectively referred to as a reaction gas. The reaction gas supplied to the anode is a fuel gas (sometimes referred to as an anode gas), and the reaction gas supplied to the cathode is an oxidant gas (sometimes referred to as a cathode gas). The fuel gas is a gas mainly containing hydrogen, and may be hydrogen. The oxidizing gas is a gas containing oxygen, and may be oxygen, air, dry air, or the like.

The fuel cell system may comprise an oxidant gas system.

The oxidant gas system supplies the oxidant gas to the fuel cell.

The oxidizing gas system may include an oxidizing gas supply unit, an oxidizing gas supply pipe, an oxidizing off-gas discharge pipe, a bypass pipe, and the like.

The oxidant gas supply unit may be an air compressor or the like. The air compressor is electrically connected to the control unit, and the rotation speed of the rotor is controlled in accordance with a control signal from the control unit. The air compressor may be disposed in an oxidant gas supply pipe.

The oxidant gas supply pipe connects the outside of the fuel cell system and the cathode inlet of the fuel cell. The oxidant gas supply pipe allows the supply of the oxidant gas from the oxidant gas supply unit to the cathode of the fuel cell. The cathode inlet may be an oxidant gas supply hole, a cathode inlet manifold, or the like. In the oxidizing gas supply pipe, an oxidizing gas inlet sealing valve may be disposed downstream of the oxidizing gas supply unit.

The oxidant gas inlet sealing valve is electrically connected to the control unit, and the oxidant gas inlet sealing valve is opened by the control unit to supply the oxidant gas to the cathode of the fuel cell. Further, the flow rate of the oxidant gas supplied to the cathode may be adjusted by adjusting the opening degree of the oxidant gas inlet sealing valve.

The oxidant off-gas discharge pipe connects the cathode outlet of the fuel cell and the outside of the fuel cell system. The oxidant off-gas discharge pipe allows the oxidant off-gas, which is the oxidant gas discharged from the cathode of the fuel cell, to be discharged to the outside of the fuel cell system. The cathode outlet may be an oxidant gas outlet, a cathode outlet manifold, or the like. A pressure regulating valve may be disposed in the oxidant off-gas discharge pipe.

The pressure regulating valve is electrically connected to the outer unit, and by opening the pressure regulating valve by the control unit, the oxidant off-gas which is the reaction oxidant gas is discharged from the oxidant off-gas discharge pipe to the outside of the fuel cell system. Further, the pressure of the oxidizing gas (cathode pressure) supplied to the cathode may be adjusted by adjusting the opening degree of the pressure regulating valve. Note that the oxidizing agent off-gas may be the same as the component of the oxidizing agent gas, may be oxygen, air, dry air, or the like, and may contain water vapor or the like.

The bypass pipe connects the oxidant gas supply pipe and the oxidant off-gas discharge pipe, and bypasses the fuel cell. The bypass pipe branches from the oxidant gas supply pipe at a branch portion downstream of the oxidant gas supply portion of the oxidant gas supply pipe, bypasses the fuel cell, and merges with the oxidant off-gas discharge pipe at a merging portion downstream of the pressure regulating valve of the oxidant off-gas discharge pipe.

A bypass valve may be disposed in the bypass pipe. The bypass valve may be a valve or the like capable of adjusting an opening degree, or may be a three-way valve for oxidizing gas. In the case of the three-way valve for oxidizing gas, it may be disposed at the branch portion of the oxidizing gas supply pipe which is the most upstream of the bypass pipe, also serves as an oxidizing gas inlet sealing valve.

The bypass valve is electrically connected to the control unit, and when the bypass valve is opened by the control unit, at least a part of the oxidant gas can be supplied to the oxidant off-gas discharge pipe by bypassing the fuel cell. In the case where the bypass valve is a three-way valve for an oxidant gas, in a case where the supply of the oxidant gas to the fuel cell is unnecessary or the like, the valve on the downstream side of the oxidant gas supply pipe of the bypass valve is closed by the control unit so that the flow of the oxidant gas becomes the bypass pipe from the oxidant gas supply pipe, and the valve on the side of the bypass pipe is opened, whereby the total amount of the oxidant gas can be supplied to the oxidant off-gas discharge pipe.

The oxidizing gas system may include a cooler (intercooler) downstream of the oxidizing gas supply unit of the oxidizing gas supply pipe. The cooler may be disposed downstream of the oxidant gas supply portion of the oxidant gas supply pipe and upstream of the branch portion with respect to the bypass pipe.

The cooler may exhibit a cooling function by circulating a cooling medium of the cooling system in and out of the cooler.

The oxidizing gas system may include a humidifier downstream of the oxidizing gas supply unit of the oxidizing gas supply pipe. The humidifier may be disposed downstream of the oxidant gas supply part of the oxidant gas supply pipe and downstream of a branch point with respect to the bypass pipe.

The humidifier may be disposed across the oxidant gas supply pipe and the oxidant off-gas discharge pipe.

The fuel cell system may comprise a fuel gas system.

The fuel gas system supplies fuel gas to the fuel cell.

The fuel gas system may include a fuel gas supply unit, a fuel gas supply pipe, a fuel off-gas discharge pipe, a circulation pipe, an ejector, and the like.

Examples of the fuel gas supply unit include a fuel tank and the like, and specific examples thereof include a liquid hydrogen tank and a compressed hydrogen tank.

The fuel gas supply pipe connects the fuel gas supply unit and the anode inlet of the fuel cell. The fuel gas supply piping enables the supply of the fuel gas containing hydrogen to the anode of the fuel cell. The anode inlet may be a fuel gas supply hole, an anode inlet manifold, or the like.

The fuel off-gas discharge pipe connects the anode outlet of the fuel cell and the outside of the fuel cell system. The anode outlet may be a fuel gas outlet hole, an anode outlet manifold, or the like.

The fuel off-gas may include the fuel gas that has passed unreacted at the anode and the moisture generated at the cathode that has reached the anode. The fuel off-gas may include a corrosive material generated in the catalyst layer, the electrolyte membrane, and the like, and an oxidant gas that may be supplied to the anode during scavenging.

The circulation pipe is branched from the fuel off-gas discharge pipe at a branch portion of the fuel off-gas discharge pipe, merges with the fuel gas supply pipe at a merging portion of the fuel gas supply pipe, and circulates the fuel off-gas as a circulation gas in the fuel gas system.

A circulation pump for circulating the circulation gas in the fuel gas system may be disposed in the circulation pipe.

An anode gas-liquid separator and an exhaust drain valve may be disposed at a branch portion of the fuel off-gas discharge pipe. The exhaust drain valve is electrically connected to the control unit, and the opening and closing of the exhaust drain valve is controlled by the control unit.

The fuel gas supply pipe of the fuel cell system according to the first embodiment may have a connection port to which a cylinder for supplying an inert gas can be connected. In the present disclosure, the inert gas may be nitrogen gas, argon gas, or the like. The cylinder may be a nitrogen cylinder, an argon gas cylinder, or the like. The connection port is not particularly limited as long as it is a component capable of connecting the fuel gas supply pipe and the cylinder. A tube for supplying an inert gas may be connected to the connection port, and the fuel gas supply pipe and the cylinder may be connected via the tube. The tube may be provided with an inert gas injection device and a regulator. The inert gas injection device may be provided with a valve for controlling on/off of the injection of the inert gas.

A fuel gas inlet sealing valve, a connection port, a connection portion with a connection pipe, a regulator, an injector, an ejector, and the like may be arranged in this order downstream of the fuel gas supply portion of the fuel gas supply pipe. The connection port may be arranged downstream of the connection with the connection pipe.

The ejector may be disposed at a junction of the fuel gas supply pipe.

The fuel gas inlet sealing valve is electrically connected to the control unit, and the fuel gas inlet sealing valve is opened by the control unit to supply the fuel gas to the anode of the fuel cell. Further, the flow rate of the fuel gas supplied to the anode may be adjusted by adjusting the opening degree of the fuel gas inlet sealing valve. The fuel gas inlet sealing valve may be a linear solenoid valve or the like.

The fuel cell system may comprise a cooling system.

The cooling system regulates the temperature of the fuel cell.

The cooling system may comprise a cooling medium line.

The cooling medium piping allows the cooling medium to circulate inside and outside the fuel cell. The cooling medium pipe communicates with a cooling medium supply hole and a cooling medium discharge hole provided in the fuel cell, and allows the cooling medium to be circulated in and out of the fuel cell.

A cooling medium supply unit may be provided in the cooling medium pipe. The cooling medium supply unit is electrically connected to the control unit. The cooling medium supply unit is driven in accordance with a control signal from the control unit. The control unit controls a flow rate of the cooling medium supplied from the cooling medium supply unit to the fuel cell. Thus, the temperature of the fuel cell is controlled. Examples of the cooling medium supply unit include a cooling water pump.

The cooling medium pipe may be provided with a radiator that dissipates heat of the cooling medium.

The cooling medium pipe may be provided with a reserve tank for storing the cooling medium.

The fuel cell system may comprise a battery.

The battery (secondary battery) may be any battery that can be charged and discharged, and examples thereof include a nickel-hydrogen secondary battery and a conventionally known secondary battery such as a lithium-ion secondary battery. The secondary battery may include a power storage element such as an electric double layer capacitor. The secondary battery may have a configuration in which a plurality of the secondary batteries are connected in series. The secondary battery supplies electric power to an air compressor or the like. The secondary battery may be rechargeable from an external power source of the vehicle, such as a household power source, for example. The secondary battery may be charged by the output of the fuel cell. The charging and discharging of the secondary battery may be controlled by the control unit.

The voltage sensor measures the voltage of the fuel cell.

The voltage sensor is electrically connected to the controller. The controller detects a voltage of the fuel cell acquired by the voltage sensor.

The connection pipe connects the oxidizing gas supply pipe and the fuel gas supply pipe.

A connection valve is disposed in the connection pipe.

The connection valve is electrically connected to the control unit. The control unit controls opening and closing of the connection valve. By opening the connection valve, the oxidant gas can be supplied from the oxidant gas system to the fuel gas system.

The control unit physically includes, for example, an arithmetic processing unit such as a CPU (central processing unit), a ROM (read-only memory) that stores control programs processed by CPU, control data, and the like, a storage device such as a RAM (random access memory) that is mainly used as various working areas for the control processing, and an input/output interface. The control unit may be, for example, a control device such as a power control unit (PCU) and an electronic control unit (ECU: Electronic Control Unit).

The control unit may be electrically connected to an ignition switch that may be mounted on the vehicle. The control unit may be operable by an external power source even when the ignition switch is turned off.

The controller previously stores a first threshold value and a second threshold value of the voltage of the fuel cell. The first threshold and the second threshold may be the same value or different values.

When the control unit starts the charge removal process of the fuel cell when the fuel cell is stopped, the control unit supplies the oxidant gas to the cathode of the fuel cell and closes the connection valve.

When the voltage of the fuel cell drops to the first threshold value, the controller stops the supply of the oxidant gas to the cathode of the fuel cell.

When the voltage of the fuel cell drops to the first threshold value, the controller supplies the oxidant gas to the anode of the fuel cell by opening the connection valve.

When the voltage of the fuel cell drops to the second threshold value, the controller closes the connection valve.

In the first embodiment of the present disclosure, it is possible to improve the speed at which the fuel gas is discharged from the fuel cell system by allowing the oxidant gas to be introduced into the fuel gas system by installing the connection pipe. Therefore, in the first embodiment of the present disclosure, although the deterioration of the fuel cell progresses slightly, the nitrogen cylinder becomes unnecessary, and it is possible to shorten the time from the entrance of the moving body such as a vehicle equipped with the fuel cell system to the unloading.

### Second Embodiment

A fuel cell system according to a second embodiment of the present disclosure includes a fuel cell and a fuel gas supply pipe. The fuel gas supply pipe has a connection port to which a cylinder for supplying an inert gas can be connected.

The fuel cell system of the second embodiment of the present disclosure may have a configuration similar to that of the fuel cell system of the first embodiment except that the fuel cell system has a connection port as an essential configuration. The cylinder and the connection port may be the same as those described in the first embodiment.

The fuel cell system of the first embodiment and the fuel cell system of the second embodiment may be combined.

In the prior art, working times for connecting the nitrogen cylinder to FC are generated. In the second embodiment of the present disclosure, the working time can be shortened by arranging a port for connecting a cylinder for supplying an inert gas to the fuel gas system.

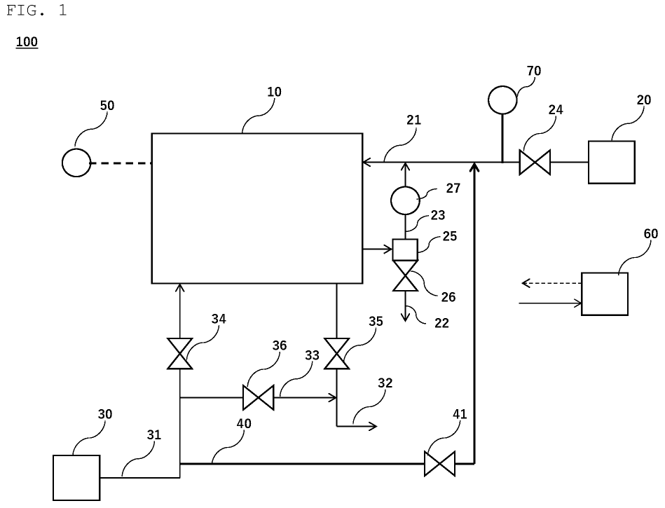

FIG. 1 shows a system configuration diagram illustrating an example of the fuel cell system of the present disclosure. In FIG. 1, the description of the cooling system is omitted for convenience.

The fuel cell system 100 includes a fuel cell 10, a fuel gas system, an oxidant gas system, a connection pipe 40, a voltage sensor 50, a control unit 60, and a connection port 70.

The fuel gas system includes a fuel gas supply unit 20, a fuel gas supply pipe 21, a fuel off gas discharge pipe 22, a circulation pipe 23, a fuel gas inlet sealing valve 24, an anode gas-liquid separator 25, an exhaust drain valve 26, and a circulation pump 27.

The oxidizing gas system includes an oxidizing gas supply unit 30, an oxidizing gas supply pipe 31, an oxidizing off-gas discharge pipe 32, a bypass pipe 33, an oxidizing gas inlet sealing valve 34, a pressure regulating valve 35, and a bypass valve 36.

The connection pipe 40 connects the fuel gas supply pipe 21 and the oxidant gas supply pipe 31. A connection valve 41 is disposed in the connection pipe 40.

In a mobile body equipped with a fuel cell system such as a fuel cell vehicle, it is assumed that a stack is unloaded and components of the fuel cell system are taken out at a service base. During this extraction, it is necessary to (1) discharge the fuel gas such as hydrogen in the fuel cell system to the outside of the system, and (2) reduce the remaining voltage of the stack to a workable state. The charge removal process is a pretreatment for safely removing a component from the fuel cell system, and refers to a process including the above (1) and (2). Hereinafter, an example in which air is used as the oxidant gas and hydrogen is used as the fuel gas will be described.

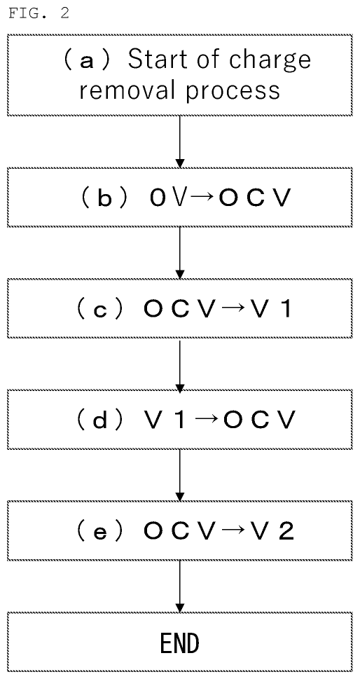

FIG. 2 shows a flowchart showing an example of voltage control performed by the fuel cell system of the present disclosure.

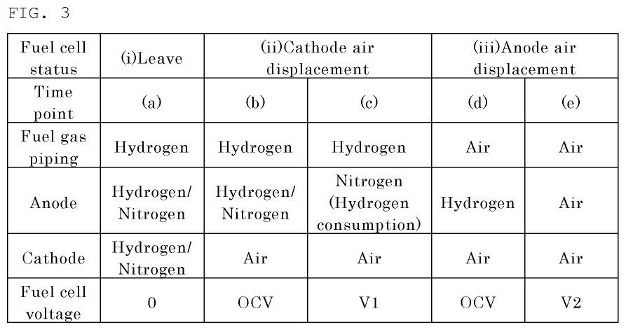

FIG. 3 shows a diagram for explaining the relationship between the state of the fuel cell, a gas present in the fuel gas system of the fuel cell, a gas present in the anode, a gas present in the cathode, and the voltage of the fuel cell.

The charge removal flow of the stack shown in FIG. 2 and the hydrogen discharge condition shown in FIG. 3 will be described below as an example. From the voltage behaviors of (i) to (iii), (i) the standing state (with bipolar hydrogen), (ii) the state where the cathode is replaced with air, (iii) the state where the anode is replaced with air, it is possible to confirm (1) the discharge of hydrogen in the fuel-cell system to the outside of the system and (2) the voltage drop.

### Step (a)

When the fuel cell is stopped, the control unit starts the charge removal process.

When the charge removal process is started, hydrogen and air are not supplied to the fuel cell, and the fuel cell is left. When hydrogen and air are not supplied to the fuel cell, the gas in the vicinity of the electrode permeates through the electrolyte membrane over time. The hydrogen transferred from the anode to the cathode reacts with oxygen present in the cathode. Therefore, as shown in FIG. 3, at the time point when the charge removal process is started, hydrogen transferred from the anode and nitrogen in the air left in the cathode as a result of the reaction of hydrogen and oxygen are present in the cathode. The anode contains hydrogen and nitrogen that has migrated from the cathode. In the piping in the fuel gas system and the anode inlet manifold in the fuel cell, there is hydrogen that has been supplied to the fuel cell until the power generation of the fuel cell is stopped.

The control unit may start the charge removal process when a start signal is input to the control unit. The start signal is input by an operator from the outside of the fuel cell system, for example.

### Step (b)

In the charge removal process, the control unit opens the oxidant gas inlet sealing valve, the pressure regulating valve, and the bypass valve, controls the air compressor to supply air to the cathode of the fuel cell, and closes the connection valve.

In step (b), the hydrogen and nitrogen of the cathode are replaced by air. When the supply of air is started, the hydrogen of the anode reacts with the supplied air. Therefore, in step (b), the voltage of the fuel-cell rises from 0V to the first open-circuit voltage. The first open circuit voltage may be a value obtained by multiplying the open circuit voltage (OCV) by a value between 0.9 and 1.0.

### Step (c)

Thereafter, in step (c), the hydrogen present at the anode reacts with the air present at the cathode and is consumed, and the anode is filled with nitrogen. In step (c), the voltage of the fuel-cell drops from the first open-circuit voltage to a first threshold V1.

The first voltage V1 is lower than the first open-circuit voltage. The first voltage V1 is a voltage obtained when no fuel gas is present in the vicinity of the fuel cell. The first voltage V1 may be a value obtained by multiplying the number of unit cells in the fuel-cell by the value of 0.1V.

The controller determines whether or not the voltage of the fuel-cell acquired from the voltage sensor is equal to or lower than the first threshold V1.

### Step (d)

When the voltage of the fuel cell drops to the first threshold V1, the control unit closes the oxidant gas inlet sealing valve, the pressure regulating valve, and the bypass valve, and stops supplying the air to the cathode of the fuel cell.

When the voltage of the fuel cell drops to the first threshold V1, the control unit opens the connection valve to supply air to the anode of the fuel cell. In step (d), the hydrogen present in the piping of the fuel gas system is replaced with air. Hydrogen present in the piping of the fuel gas system moves to the anode. The hydrogen transferred to the anode reacts with the cathode air. Therefore, in step (d), the voltage of the fuel-cell rises from the first threshold V1 to the second open-circuit voltage. The second open circuit voltage may be a value obtained by multiplying the open circuit voltage by a value between 0.9 and 1.0. On the other hand, when the voltage of the fuel cell acquired from the voltage sensor exceeds the first threshold V1, the control unit continues supplying air to the cathode of the fuel cell.

### Step (e)

After step (d), in step (e), the hydrogen present at the anode reacts with the air present at the cathode and is consumed and is filled with the air that has migrated from the piping of the fuel gas system. In step (e), the voltage of the fuel-cell drops from the second open-circuit voltage to a second threshold V2.

The controller determines whether or not the voltage of the fuel-cell acquired from the voltage sensor is equal to or lower than the second threshold V2.

The second voltage V2 is lower than the second open-circuit voltage. The second voltage V2 is a voltage at which components can be safely removed from the fuel-cell system. The second voltage V2 may be a voltage obtained when the fuel gas of the anode in the fuel cell is consumed. The second voltage V2 may be lower than the first voltage V1 or may be equal to the first voltage V1. The second thresholds may be 25V.

When the voltage of the fuel cell drops to the second threshold value, the controller closes the connection valve and stops the gas supply to the fuel cell.

As a result, the inside of the fuel gas system and the inside of the oxidant gas system of the fuel cell system can be filled with air, and the charge removal process is completed. On the other hand, when the voltage of the fuel cell acquired from the voltage sensor exceeds the second threshold V2, the control unit continues supplying air to the anode of the fuel cell.

Step (d′)

When the fuel cell system has the connection port, the control unit may perform the following processing in step (d).

When the voltage of the fuel cell drops to the first threshold V1, the controller connects the nitrogen cylinder to the connection port instead of opening the connection valve, and supplies nitrogen from the nitrogen cylinder to the anode of the fuel cell. In step (d′), the hydrogen present in the piping of the fuel gas system is replaced with nitrogen.

Step (e′)

After step (d′), in step (e′), the hydrogen present at the anode reacts with the air present at the cathode and is consumed and filled with nitrogen that has migrated from the piping of the fuel gas system.

From the voltage change of the fuel cell in the fuel cell system of the present disclosure, it is possible to grasp the discharge completion time point of the fuel gas in the fuel cell system. Therefore, the time required for discharging the fuel gas from the fuel cell system can be shortened.

According to the fuel cell system of the present disclosure, components can be safely removed from the fuel cell system. In addition, since the discharge completion time of the fuel gas can be grasped from the change in the voltage of the fuel cell, the removal of the components of the fuel cell system can be started at an early stage as compared with the case where the discharge completion time of the fuel gas cannot be grasped.

### REFERENCE SIGNS LIST

10 Fuel cell
20 Fuel gas supply section
21 Fuel gas supply piping
22 Fuel off-gas discharge piping
23 Circulation piping
24 Fuel gas inlet sealing valve
25 Anode gas-liquid separator
26 Exhaust drain valve
27 Circulation pump
30 Oxidant gas supply section
31 Oxidant gas supply piping
32 Oxidant off-gas discharge piping
33 Bypass piping
34 Oxidant gas inlet sealing valve
35 Pressure regulating valve
36 Bypass valve
40 Connecting piping
41 Connecting valve
50 Voltage sensor
60 Control unit
70 Connection port
100 Fuel cell system

1. A fuel cell system,
wherein the fuel cell system comprises a fuel cell, an oxidant gas supply pipe, a fuel gas supply pipe, a connection pipe, a voltage sensor and a control unit;
wherein the connection pipe connects the oxidant gas supply pipe and the fuel gas supply pipe;
wherein a connection valve is disposed in the connection pipe;
wherein the voltage sensor is configured to measure a voltage of the fuel cell;
wherein the control unit is configured to control opening and closing of the connection valve;
wherein the control unit is configured to preliminarily store a first threshold value and a second threshold value of the voltage of the fuel cell;
wherein, when the control unit starts a charge removal process of the fuel cell when the fuel cell is stopped, the control unit is configured to supply the oxidant gas to a cathode of the fuel cell and closes the connection valve;
wherein, when the voltage of the fuel cell decreases to the first threshold value, the control unit is configured to stop the supply of the oxidant gas to the cathode of the fuel cell, and the control unit is configured to supply the oxidant gas to an anode of the fuel cell by opening the connection valve; and
wherein, when the voltage of the fuel cell decreases to the second threshold value, the control unit is configured to close the connection valve.

2. A fuel cell system,
wherein the fuel cell system comprises a fuel cell and a fuel gas supply pipe, and
wherein the fuel gas supply pipe includes a connection port to which a cylinder for supplying an inert gas can be connected.

3. The fuel cell system according to claim 1, wherein the fuel gas supply pipe includes a connection port to which a cylinder for supplying an inert gas can be connected.
